(19) United States
(12) Patent Application Publication
(10) Pub. No.: US 2012/0140999 A1
(43) Pub. Date: Jun. 7, 2012

(54) IMAGE PROCESSING METHOD, IMAGE PROCESSING APPARATUS, AND IMAGE PROCESSING PROGRAM

(75) Inventor: Koichiro Kishima, Kanagawa (JP)

(73) Assignee: Sony Corporation, Tokyo (JP)

(21) Appl. No.: 13/305,246

(22) Filed: Nov. 28, 2011

(30) Foreign Application Priority Data
Dec. 3, 2010 (JP) 2010-270284

(51) Int. Cl. G06K 9/00

(52) U.S. Cl. 382/128

(57) ABSTRACT

Disclosed herein is an image processing method, including: comparing a first low-magnification image as a low-magnification image of a first observation object, and a second low-magnification image of a second observation object similar to the first observation object with each other by an image comparing portion, thereby obtaining a difference between a position of the first observation object in the first low-magnification image, and a position of the second observation object in the second low-magnification image; and displaying a first high-magnification image as a high-magnification image of the first observation object, and a second high-magnification image as a high-magnification image of the second observation object in conjunction with each other in accordance with the difference on a display device by an image displaying portion.

### BACKGROUND

The present disclosure relates to an image processing method, an image processing apparatus, and an image processing program with which microscopic images can be displayed in conjunction with one another.

A method of dyeing a body tissue (specimen material), and observing the body tissue thus dyed with a microscope, thereby diagnosing presence or absence of a lesion, and the like is known in the field of a pathological diagnosis, or the like. In this case, it is frequently carried out that sectors close to one another of slice pieces of one specimen material are dyed with different stains. For example, there are the case where Hematoxilin-Eosion (HE) dyeing is carried out for one section of the specimen material, and with regard to a specimen material showing a doubtful staining reaction, fluorescence stain is carried out for another section of the specimen material, thereby minutely observing another section, and so forth.

If microscopic images of the sections dyed with such different stains can be displayed adjacent to one another on a display device, the situation of the different dyeings of the same region can be observed, which is convenient for a user. In order to attain this, however, corresponding areas of the sections in the different images need to be displayed on the display device.

For example, a cell image analyzer disclosed in Japanese Patent Laid-Open No. 2010-145366 (refer to a paragraph [0026] and FIG. 3), an area in which a cell exists in a picked up image can be detected in image processing with a profile of the cell as a reference. If such a detecting method is used, it is possible to acquire positional information on a region of a specimen material in the picked up image. Also, the positions of the regions of the specimen material in the different images are compared and aligned with one another, which results in that the images of the corresponding areas of the sections can be displayed on the display device.

### SUMMARY

However, the detecting method disclosed in Japanese Patent Laid-Open No. 2010-145366 can be applied when a feature structure like the profile of the cell exists in the image. For example, in the dyeing observation described above, the imaging range of the microscope is limited and thus the feature structure such as the profile of the section does not appear in the image capturing region in some cases because especially, the stain of the fluorescence stain is generally expensive. In such cases, it may be impossible to obtain the positional information on the specimen material in the image, and thus it may be impossible to display the corresponding areas of the different images on the display device.

The present disclosure has been made in order to solve the problems described above, and it is therefore desirable to provide an image processing method, an image processing apparatus, and an image processing program with which microscopic images of observation objects having the similar structures can be displayed in conjunction with one another.

In order to attain the desire described above, according to an embodiment of the present disclosure, there is provided an image processing method, including: comparing a first low-magnification image as a low-magnification image of a first observation object, and a second low-magnification image of a second observation object similar to the first observation object with each other by an image comparing portion, thereby obtaining a difference between a position of the first observation object in the first low-magnification image, and a position of the second observation object in the second low-magnification image; and displaying a first high-magnification image as a high-magnification image of the first observation object, and a second high-magnification image as a high-magnification image of the second observation object in conjunction with each other in accordance with the difference on a display device by an image displaying portion.

Since the first low-magnification image is an image obtained by picking up the image of the first observation object at the low magnification, the visual view range is larger in the first low-magnification image than in the first high-magnification image. Also, since the second low-magnitude image is also an image obtained by picking up the image of the second observation object at the low magnification, the visual view range is larger in the second low-magnification image than in the first low-magnification image. For this reason, an area of the first observation object not contained in the first high-magnification image is contained in the first low-magnification image in some cases. Or, an area of the second observation object not contained in the second high-magnification image is contained in the second low-magnification image in some cases. Therefore, the first low-magnification image and the second low-magnification image are compared with each other, which results in that the first high-magnification image and the second high-magnification image are aligned with each other by using information on the areas not contained in such high-magnification images, and thus the first high-magnification image, and the second high-magnification image can be displayed in conjunction with each other.

In order to attain the desire described above, according to another embodiment of the present disclosure, there is provided an image processing method, including: detecting an area in which a first observation object exists as a first area in a first low-magnification image obtained by picking up an image of the first observation object at a low-magnification by a first area detecting portion; detecting an area in which a second observation object exists as a second area in a second low-magnification image obtained by picking up an image of the second observation object similar to the first observation object at a low magnification by a second area detecting area; comparing the first low-magnification image and the second low-magnification image with each other by an image comparing portion, thereby obtaining a difference between a position of the first observation object in the first low-magnification image, and a position of the second observation object in the second low-magnification image; and displaying a first high-magnification image obtained by picking up an image of the first area at a high magnification, and a second high-magnification image obtained by picking up an image of the second area at the high magnification in conjunction with each other in accordance with the difference on a display device by an image displaying portion.

The first high-magnification image is the image obtained by picking up the image of the first area in which the first observation object exists in the first low-magnification image at the high magnification. Also, the second high-magnification image is the image obtained by picking up the image of the second area in which the second observation object exists in the second low-magnification image at the high magnification. However, for example, when the observation object is located outside a cover glass of a preparation, there exists the case where the entire image of the first observation object is not contained in the first high-magnification image, or the entire image of the second observation object is not contained in the second high-magnification image. However, according to the embodiment of the present disclosure, the first low-magnification image and the second low-magnification image each having the wider visual view range are used in the alignment between the first high-magnification image and the second high-magnification image, which results in that even in such cases, the first high-magnification image and the second high-magnification image can be aligned with each other, and thus the first high-magnification image and the second high-magnification image can be displayed in conjunction with each other.

In order to attain the desire described above, according to yet another embodiment of the present disclosure, there is provided an image processing apparatus, including: a first area detecting portion detecting an area in which a first observation object exists as a first area in a first low-magnification image obtained by picking up an image of a first observation object at a low magnification; a second area detecting portion detecting an area in which a second observation object similar to the first observation object exists as a second area in a second low-magnification image obtained by picking up an image of a second observation object at the low magnification; an image comparing portion comparing the first low-magnification image and the second low-magnification image with each other, thereby obtaining a difference between a position of the first observation object in the first low-magnification image, and a position of the second observation object in the second low-magnification image; and an image displaying portion causing a display device to display thereon a first high-magnification image obtained by picking up an image of the first area at a high magnification and a second high-magnification image obtained by picking up an image of the second area at the high magnification in conjunction with each other in accordance with the difference.

In order to attain the desire described above, according to further embodiment of the present disclosure, there is provided an image processing program functioning so as to include: a first area detecting portion detecting an area in which a first observation object exists as a first area in a first low-magnification image obtained by picking up an image of a first observation object at a low magnification; a second area detecting portion detecting an area in which a second observation object similar to the first observation object exists as a second area in a second low-magnification image obtained by picking up an image of a second observation object at the low magnification; an image comparing portion comparing the first low-magnification image and the second low-magnification image with each other, thereby obtaining a difference between a position of the first observation object in the first low-magnification image, and a position of the second observation object in the second low-magnification image; and an image displaying portion causing a display device to display thereon a first high-magnification image obtained by picking up an image of the first area at a high magnification and a second high-magnification image obtained by picking up an image of the second area at the high magnification in conjunction with each other in accordance with the difference.

As set forth hereinabove, according to an embodiment of the present disclosure, it is possible to provide the image processing method, the image processing apparatus, and the image processing program with which the microscopic images of the observation objects having the similar structures can be displayed in conjunction with one another.

### BRIEF DESCRIPTION OF THE DRAWINGS

FIG. 1 is a schematic diagram showing a configuration and a construction of a microscope system including an image processing apparatus according to an embodiment of the present disclosure;

FIG. 2 is a block diagram showing a functional configuration of the microscope system shown in FIG. 1;

FIG. 3 is a flow chart showing an operation of the microscope system shown in FIG. 1 for a first observation object;

FIG. 4 is a flow chart showing an operation of the microscope system shown in FIG. 1 for a second observation object;

FIG. 5 is a flow chart showing an operation for comparing an image of the first observation object and an image of the second observation object in the microscope system shown in FIG. 1;

FIG. 6 shows an example of a first low-magnification image picked up by the microscope system shown in FIG. 1;

FIGS. 7A and 7B are respectively schematic views each showing a specimen material area detected from the first low-magnification image by the microscope system shown in FIG. 1;

FIG. 8 is a view conceptually showing a microscope image capturing area set in the first low-magnification image by the microscope system shown in FIG. 1;

FIG. 9 is a view showing an example of a first high-magnification image picked up by the microscope system shown in FIG. 1;

FIG. 10 is a view showing an example of a second low-magnification image picked up by the microscope system shown in FIG. 1;

FIGS. 11A and 11B are respectively views each showing a specimen material area detected from the second low-magnification image by the microscope system shown in FIG. 1;

FIG. 12 is a view conceptually showing a microscope image capturing area set in the second low-magnification image by the microscope system shown in FIG. 1;

FIG. 13 is a view showing an example of a second high-magnification image picked up by the microscope system shown in FIG. 1;

FIGS. 14A to 14C are respectively conceptual views showing a situation of a comparison between the first low-magnification image and the second low-magnification image by the microscope system shown in FIG. 1;

FIG. 15 is a view showing an example of the first high-magnification image and the second high-magnification image which are displayed on a display device by the microscope system shown in FIG. 1; and

FIGS. 16A and 16B are respectively schematic views each showing a preparation observed by the microscope system shown in FIG. 1.

### DETAILED DESCRIPTION OF THE PREFERRED EMBODIMENTS

Embodiments of the present disclosure will be described in detail hereinafter with reference to the accompanying drawings.

### Configuration and Construction of Microscope System

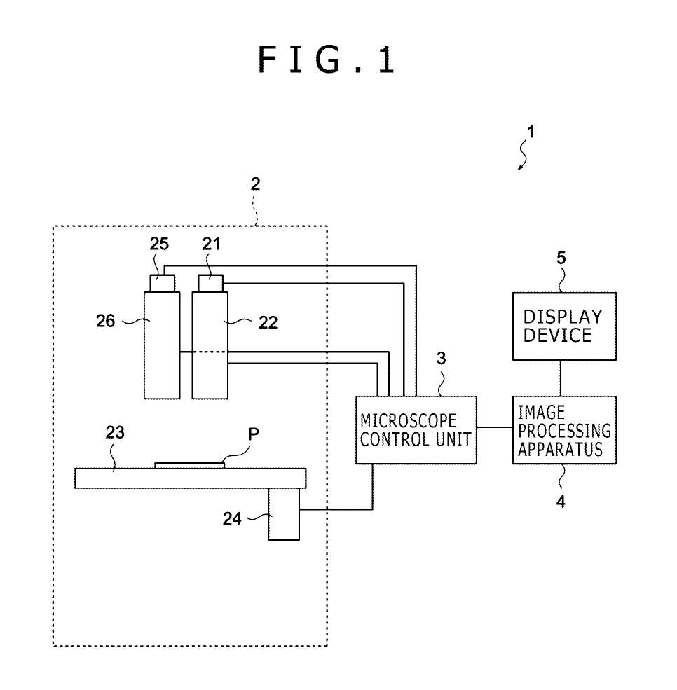

FIG. 1 is a schematic diagram showing a configuration and a construction of a microscope system including an image processing apparatus according to an embodiment of the present disclosure.

As shown in FIG. 1, the microscope system 1 includes a microscope 2, a microscope control unit 3, an image processing apparatus 4, and a display device 5. The microscope control unit 3 is an incidental electrical unit for controlling individual portions of the microscope 2, and the image processing apparatus 4 is an information processing apparatus. The display device 5 is composed of a Cathode Ray Tube (CRT), a liquid crystal display device, or the like. The configuration and construction of the microscope system 1 is merely exemplified, and thus the microscope system 1 can adopt a different configuration and construction.

The microscope 2 is an optical microscope whose portions are operated in accordance with a control signal sent from the microscope control unit 3. Thus, a general microscope can be adopted as the microscope 2. Specifically, the microscope 2 can include a high-power imaging device 21, a high-power lens barrel 22, a stage 23, a stage driving portion 24, a low-power imaging device 25, and a low-power lens barrel 26. A preparation P placed on the stage 23 is shown in FIG. 1.

The high-power imaging device 21 is a digital imaging device including an image pickup element such as a Charge Coupled Device Image Sensor (CCD) or a Complementary Metal Oxide Semiconductor (CMOS). Thus, an imaging device for microscope image capturing can be used as the high-power imaging device 21. The high-power imaging device 21 is provided in the high-power lens barrel 22, and can pick up a microscopic image of the preparation P through an optical system of the high-power lens barrel 22. The high-power imaging device 21 is connected to the microscope control unit 3 and receives control for an imaging timing and an exposure amount. The high-power imaging device 21 outputs image data produced to the image processing apparatus 4 through the microscope control unit 3.

The low-power imaging device 25 is a digital imaging device including an image pickup element such as a CCD or a CMOS. The low-power imaging device 25 is provided in the low-power lens barrel 26, and can pick up an entire image of the preparation P through an optical system of the low-power lens barrel 26. A low-power imaging device in which the number of pixels, for example, is 24 mega-pixels (24 M) can be used as the low-power imaging device 25. The low-power imaging device 25 is connected to the microscope control unit 3 and receives control for an imaging timing and an exposure amount. The low-power imaging device 25 outputs image data produced to the image processing apparatus 4 through the microscope control unit 3.

The high-power lens barrel 22 builds therein high-power objective lenses, and a position adjusting mechanism for these high-power objective lenses. Also, the high-power lens barrel 22 can enlarge an image of the preparation P at a predetermined magnification, for example, at a magnification such as a 20-fold magnification or a 40-fold magnification. The high-power lens barrel 22 is connected to the microscope control unit 3 and receives control for focal depth adjustment (auto-focus) and the like.

The low-power lens barrel 26 builds therein low-power objective lenses or a reduction optical system, and a position adjusting mechanism for these low-power objective lenses or the reduction optical system. Also, the low-power lens barrel 26 can enlarge or reduce the image of the preparation P at a predetermined magnification, for example, at a magnification such as a 0.5-fold magnification, the same magnification, or a 0.2-fold magnification. In addition, the low-power lens barrel 26 is connected to the microscope control unit 3 and receives the control for the focal depth adjustment (auto-focus) and the like.

Note that, in FIG. 1, the high-power lens barrel 22 and the high-power imaging device 21, and the low-power lens barrel 26 and the low-power imaging device 25 are provided separately from each other. However, the high-power lens barrel 22 and the high-power imaging device 21, and the low-power lens barrel 26 and the low-power imaging device 25 can also be constructed in the form of one lens barrel and one imaging device, respectively. In this case, the exchange of the objective lens provided in the lens barrel makes the switching between the high magnification and the low magnification possible.

The stage 23 supports the preparation P, and can move in a direction vertical to the optical system of the low-power lens barrel 26 and the high-power lens barrel 22 (in a direction of an optical axis of the optical system) and in a direction horizontal thereto (in a direction perpendicular to the optical axis direction). The stage 23 is provided with a transmission window for transmitting a light emitted from a light source for illumination (not shown). The preparation P is disposed above the transmission window. In addition, the stage 23 can move the preparation P to imaging areas of the high-power lens barrel 22 and the low-power lens barrel 26. Or, a low-magnification image and a high-magnification image of the preparation P may also be acquired by moving both of the high-power lens barrel 22 and the low-power lens barrel 26.

The stage driving portion 24 builds therein a drive mechanism such as a stepping motor, and moves the stage 23 in the vertical direction and in the horizontal direction. The stage driving portion 24 is connected to the microscope control unit 3 and receives control for a movement direction and a movement amount.

The microscope 2 is configured and constructed in the manner as described above. It is noted that although a microscope in which the adjustment for the focal depth, the imaging, and the like are automatically carried out by the microscope control unit 3 is supposed as the microscope 2, the present disclosure is by no means limited thereto, and thus a microscope which is manually controlled by the user can also be adopted.

The microscope control unit 3 is composed of the electrical unit such as a microprocessor, and controls the individual portions of the microscope 2 in the manner as described above. The microscope control unit 3 is connected to the image processing apparatus 4, and reflects the output from the image processing apparatus 4 in the control for the microscope 2.

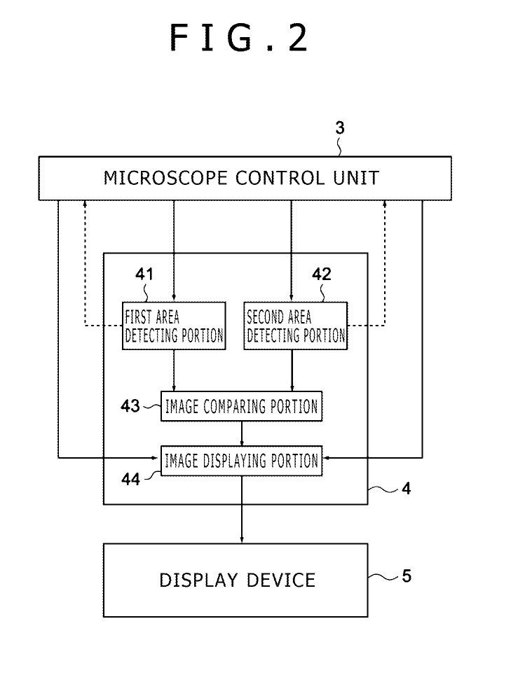

The image processing apparatus 4 subjects image data supplied thereto either from the low-power imaging device 25 or from the high-power imaging device 21 to processing which will be described later, and displays an image for observation on the display device 5. FIG. 2 is a block diagram showing a functional configuration of the image processing apparatus 4.

As shown in FIG. 2, the image processing apparatus 4 includes a first area detecting portion 41, a second area detecting portion 42, an image composing portion 43, and an image displaying portion 44. Both of the first area detecting portion 41 and the second area detecting portion 42 are connected to the microscope control unit 3. The image comparing portion 43 is connected to each of the first area detecting portion 41 and the second area detecting portion 42. The image displaying portion 44 is connected to the image comparing portion 43, and is also connected to the microscope control unit 3. The first area detecting portion 41, the second area detecting portion 42, the image composing portion 43, and the image displaying portion 44 of the image processing apparatus 4 function in accordance with operations of a processor, a memory, a program, and the like, and details thereof will be described later.

The display device 5 is a display device such as the CRT or the liquid crystal display device, and displays thereon an output from the image display portion 44 of the image processing apparatus 4 in the form of an image.

The microscope system 1 is configured in the manner as described above. It is noted that the image processing apparatus 4 may not compose the microscope system 1 together with specific models of microscope 2 and microscope control unit 3, and thus can be additionally introduced into an arbitrary microscope system.

### With Respect to Observation Object

In the embodiment, “a first observation object” and “a second observation object” are each set as an observation object. The first observation object and the second observation object are similar to each other. The similarity between the first observation object and the second observation object means that in the first observation object and the second observation object, the connection of the profile and the tissue structure can be confirmed. Specifically, it is possible to suppose that the first observation object is obtained by dyeing a section of a certain body tissue by utilizing some sort of dyeing method (such as a Hematoxylin-Eosion (HE) dyeing method), and the second observation object is obtained by dyeing the same section by utilizing different dyeing methods (such as 4′,6-diamidino-2-phenylindole (DAPI) dyeing methods). In addition, of plural sections produced by slicing a certain body tissue, the sections adjacent or close to each other can be made the first observation object and the second observation object, respectively.

In the dyeing observation carried out in the pathological diagnosis, it is often carried out that one of the sections produced by slicing one pathological tissue into plural sections is subjected to one dyeing, and other sections are stored as a backup, and when the abnormality is observed in the section thus dyed, one of the backup sections is subjected to another dyeing and are then minutely observed. In such a case, the former section can be made the first observation object, and the latter section can be made the second observation object.

As described above, the first observation object and the second observation object are similar to each other. Thus, the first observation object and the second observation object are displayed in conjunction with each other on the display device, which results in that corresponding tissue structures of the first observation object and the second observation object can be compared with each other. It is noted that carrying out the display of the observation objects in conjunction with each other means that the enlargement, the reduction, the movement or the like is similarly carried out in both of the images.

Here, for displaying the microscopic image of the first observation object, and the microscopic image of the second observation object in conjunction with each other, it is necessary to register both of the microscopic images. The registration is such that the feature structures in both of the microscopic images are extracted, and are set as corresponding structures. For example, a profile line or the like of the observation objects displayed in both of the microscopic images are frequently used in the registration.

The structures which can be registered may not be contained either in both of or one of the microscopic image of the first observation object and the microscopic image of the second observation object in some cases. For example, in the case of a preparation shown in FIG. 16A, a cover glass C1 is larger in size than an observation object T1 placed on a slide glass S1. In this case, a profile line of the observation object T1 is contained in the microscopic image of the preparation. On the other hand, in the case of a preparation shown in FIG. 16B, a cover glass C2 is smaller in size than an observation object T2 placed on a slide glass S2. Since the microscope imaging is out of focus for an area in which no cover glass exists, no profile line of the observation object T2 is contained in the microscopic image of this preparation. Therefore, in the case of the preparation as shown in FIG. 16B, it may be impossible to carry out the registration utilizing the profile of the observation object.

In the embodiment, even when no profile of the observation object is contained in the microscopic image as shown in FIG. 16B, the registration can be carried out. In the following description, it is supposed that the profile of the first observation object is covered with the cover glass, and no profile of the second observation object is covered with the cover glass. In addition, a preparation in which the first observation object is set is made a preparation P1, and a preparation in which the second observation object is set is made a preparation P2.

### Operation of Microscope System

An operation of the microscope system 1 will be described below.

The operation of the microscope system 1 will be described in the first to third operations. The first operation is an operation for the first observation object, and the second operation is an operation for the second observation object. The third operation is an operation for comparing the first observation object and the second observation object with each other.

### Operation for First Observation Object

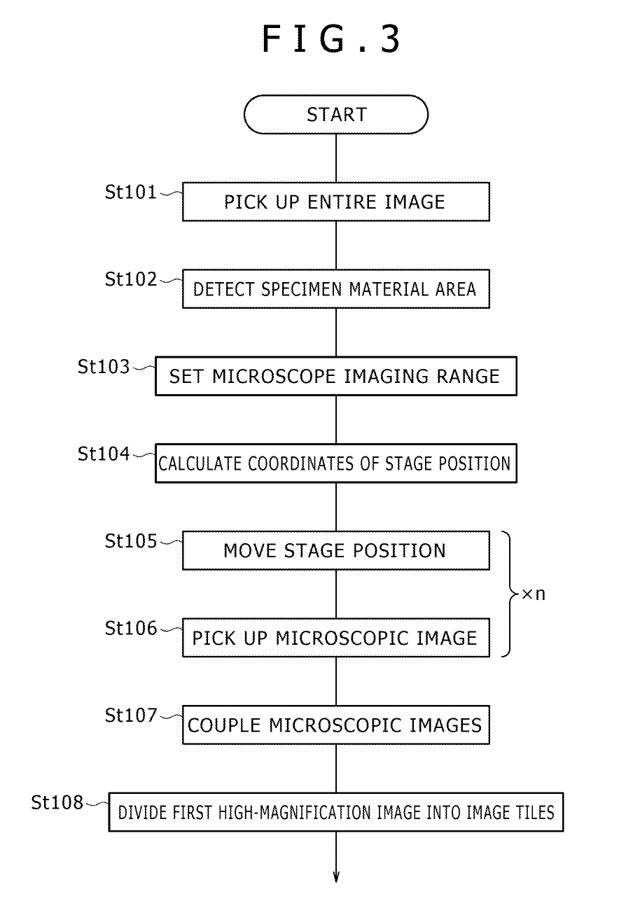

A description will now be given with respect to the operation of the microscope system 1 for the first observation object. FIG. 3 is a flow chart showing the operation of the microscope system 1 for the first observation object. It is noted that the preparation P1 is previously placed on the stage 23.

When a start instruction is inputted by the user, the low-power imaging device 25 picks up “an entire image” of the preparation P1 (St101). The entire image is an image in which the entire preparation P1 is fitted within a visual view of the low-power imaging device 25. The microscope control unit 3 outputs to the low-power lens barrel 26 a control signal in such a way that a magnification (such as a two-fold magnification, the same magnification or a 0.5-fold magnification) specified by the user is obtained, and the focus is obtained at the magnification thus specified. Subsequently, in response to the control signal outputted from the microscope control unit 3, the low-power imaging device 25 picks up an image of the preparation P1. The entire image is set as “a first low-magnification image.”

FIG. 6 shows an example of the first low-magnification image. The image shown in FIG. 6 is an image obtained by picking up an image of a section of a pork loin as the first observation object dyed by utilizing the HE dyeing method. Although the first low-magnification image shown in FIG. 6 is a monochrome image, the monochrome image is obtained by transferring thereinto the picked up color image. The data on the first low-magnification image is outputted to the first area detecting portion 41 of the image processing apparatus 4 through the microscope control unit 3. In addition, since the data on the first low-magnification image is used in a subsequent step, the data on the first low-magnification image is preserved in the image processing apparatus 4 without being erased.

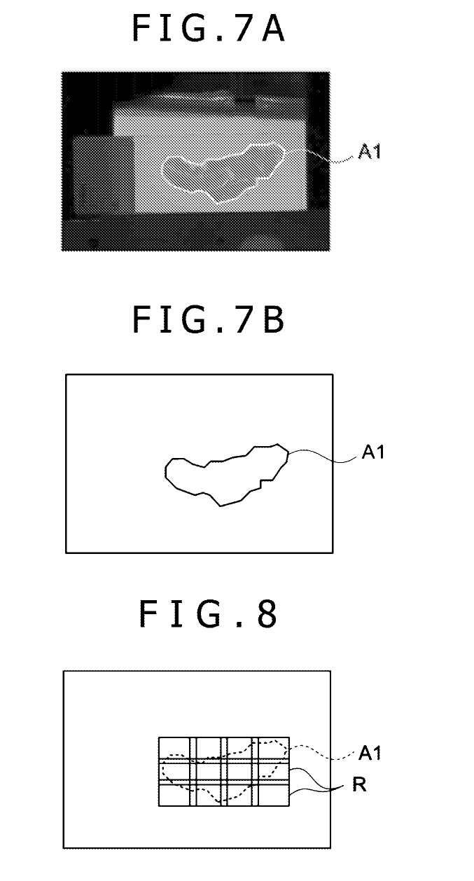

Next, the first area detecting portion 41 detects “a specimen material area” in the first low-magnification image (St102). The specimen material area is an area in which the first observation object, that is, the section of the pork loin in this case exists. FIGS. 7A and 7B are respectively schematic views each showing the specimen material area thus detected. FIG. 7A shows a profile of the specimen material area in a state in which the profile of the specimen material area is superimposed on the low-magnification image, and FIG. 7B shows the profile of the specimen material area, and a peripheral edge of the first low-magnification image. In FIGS. 7A and 7B, the profile of the specimen material area is shown as an area A1.

In the subsequent step, the microscope system 1 picks up the image of the specimen material area at the high magnification. However, since it becomes wasteful to pick up an image of an area in which no observation object exists at the high magnification, in Step St102, an area is detected in which the observation object whose image is to be picked up at the high magnification exists. Processing, utilizing a contrast (visual features such as a luminance and a color) of an image, such as area extraction based on the threshold value processing and labeling processing, or edge detection using a digital filter can be used for detection of the specimen material area.

Next, the image processing apparatus 4 sets “a microscope imaging range” in the first low-magnification image (St103). FIG. 8 is a view conceptually showing the microscope imaging range. A specimen material area (an area A1), and the microscope imaging range (shown as a range R) set on the specimen material area are both shown in FIG. 8.

The microscope imaging range is a range corresponding to the visual view range of the high-power imaging device 21 through the high-power lens barrel 22 set to a predetermined enlargement magnification. The image processing apparatus 4 determines a size of the microscope imaging range in correspondence to the enlargement magnification inputted by the user. When the entire specimen material area is not contained in one microscope imaging range, as shown in FIG. 8, the image processing apparatus 4 disposes plural microscope imaging ranges. It is noted that the image processing apparatus 4 can dispose the microscope imaging ranges in such a way that as shown in FIG. 8, peripheral portions thereof are superimposed on one another. This process is carried out for convenience in a microscopic image coupling step which will be described later.

Next, the image processing apparatus 4 calculates “the coordinates of a position of the stage” as the coordinates of the position of the stage 23 for fitting each of the microscope imaging ranges described above within the visual view of the high-power imaging device 21 (St104). Specifically, the image processing apparatus 4 calculates a difference between the coordinates of a central position of the first low-magnification image, and the coordinates of a central position of one microscope imaging range. Also, the image processing apparatus 4 applies the difference to the coordinates, of the position of the stage 23 when the first low-magnification image is picked up, data on which is supplied from the microscope control circuit 3, and sets the resulting coordinates as the coordinates of the position of the stage 23 about the microscope imaging range concerned. The image processing apparatus 4 outputs the data on the coordinates of the positions of the stage 23 corresponding to the microscope imaging ranges, respectively, to the microscope control unit 3. In addition, when plural microscope imaging ranges are set, the image processing apparatus 4 determines the most efficient order of the imaging, that is, the order of the imaging with which the drive distance of the stage 23 becomes shortest, and outputs data on the order of the imaging to the microscope control unit 3.

Next, the microscope control unit 3 moves the position of the stage 23 by using the stage driving portion 24 (St105). The microscope control unit 3 controls the state driving portion 24 in such a way that any one of the microscope imaging ranges agrees with the visual view of the high-power imaging device 21 in accordance with the data on the coordinates of the position of the stage 23 supplied thereto in the processing in St104.

Next, the high-power imaging device 21 picks up “a microscopic image” of the preparation P1 (St105). The microscopic image is a microscopic enlarged image of the preparation P1. The microscope control unit 3 outputs a control signal to the high-power lens barrel 22 in such a way that the enlargement magnification specified by the user is obtained, and the focus is obtained at the enlargement magnification thus specified. The high-power imaging device 21 outputs the data on the microscopic image to the image processing apparatus 4.

When plural microscope imaging ranges are set, the microscope control unit 3 moves the position of the stage 23 again by using the stage driving portion 24, and causes the high-power imaging device 21 to pick up an image of the next microscope imaging range of the preparation P1. The microscope control unit 3 repetitively carries out both of the movement of the position of the state 23 (St105), and the imaging of the microscopic image by the high-power imaging device 21 (St106) until the images of all of the microscope imaging ranges are picked up.

When plural microscopic images adjacent to one another are picked up, the image processing apparatus 4 couples the individual microscopic images to one another (St107). Specifically, the image processing apparatus 4 extracts plural feature points in a superimposing range of the two sheets of adjacent microscopic images, and can stitch these images in such a way that the feature points agree with one another. As a result, even when the continuous specimen material areas are larger in size than one microscope imaging range, it becomes possible to acquire the continuous microscopic image of the specimen material area concerned. The microscopic image, obtained through the coupling, of the preparation P1 thus produced is set as “a first high-magnification image.”

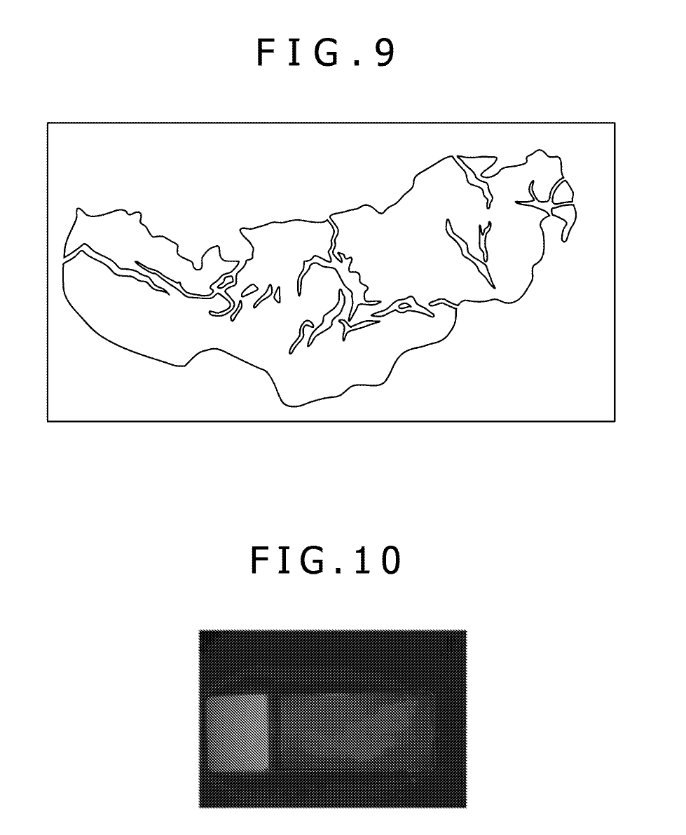

FIG. 9 is a schematic view of the first high-magnification image. As shown in FIG. 9, the first high-magnification image is obtained by picking up an image of only the specimen material area lying on the preparation P1 at the high magnification.

Next, the image processing apparatus 4 divides the first high-magnification image into image tiles (St108). The image processing apparatus 4 divides the first high-magnification image into plural square partitions, for example, 256 square partitions. This process is carried out for the purpose of saving a storage capacity of a memory or the like in the case where the first high-magnification image is displayed on the display device 5, and making the handling of the first high-magnification image easy. The image processing apparatus 4 adds predetermined pieces of positional information on the image tiles in the first high-magnification image to heads of the image tiles, respectively.

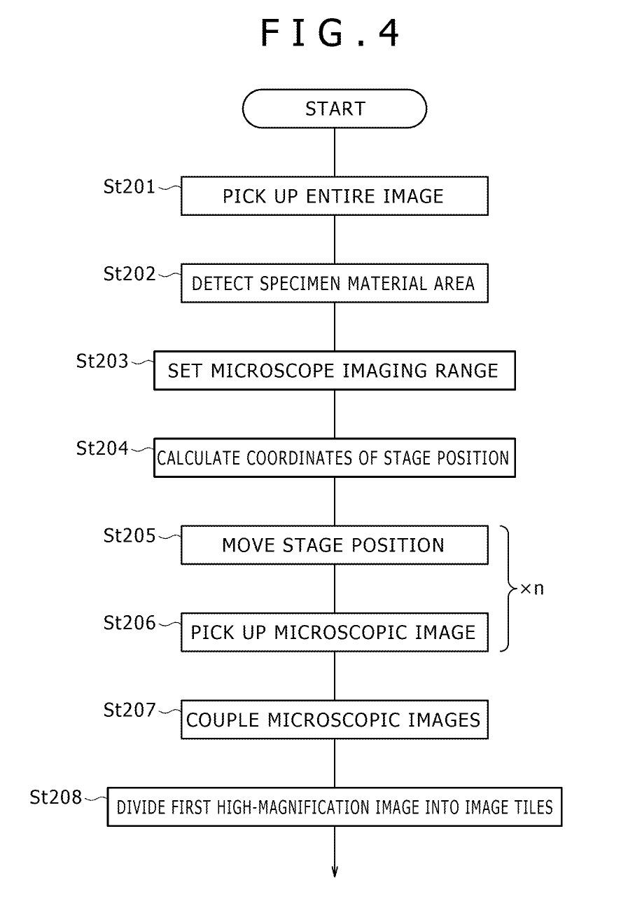

The operation of the microscope system 1 for the first observation object shown in FIG. 3 is as described above. Subsequently, the operation of the microscope system 1 proceeds to an operation for the second observation object shown in FIG. 4. It is noted that the operation of the microscope system 1 for the first observation object, and the operation of the microscope system 1 for the second observation object which will be shown below may be reversed in order.

### Operation for Second Observation Object

A description will now be given with respect to the operation of the microscope system 1 for the second observation object. FIG. 4 is a flow chart showing the operation of the microscope system 1 for the second observation object. It is noted that it is supposed that the preparation P2 is previously placed on the stage 23.

When a start instruction is inputted by the user, the low-power imaging device 25 picks up “an entire image” of the preparation P2 (St201). The entire image is an image in which the entire preparation P2 is fitted within the visual view of the low-power imaging device 25. The microscope control unit 3 outputs to the low-power lens barrel 26 a control signal in such a way that a magnification (such as a two-fold magnification, the same magnification or a 0.5-fold magnification) specified by the user is obtained, and the focus is obtained at the magnification thus specified. Subsequently, in response to the control signal outputted from the microscope control unit 3, the low-power imaging device 25 picks up an image of the preparation P2. The entire image is set as “a second low-magnification image.”

FIG. 10 shows an example of the second low-magnification image. The image shown in FIG. 10 is an image obtained by picking up an image of a section of a pork loin as the second observation object dyed by utilizing the DAPI dyeing method. Although the second low-magnification image shown in FIG. 10 is a monochrome image, the monochrome image is obtained by transforming thereinto the picked up color image. The data on the second low-magnification image is outputted to the second area detecting portion 42 of the image processing apparatus 4 through the microscope control unit 3. In addition, since the data on the second low-magnification image is used in a subsequent step, the data on the second low-magnification image is preserved in the image processing apparatus 4 without being erased.

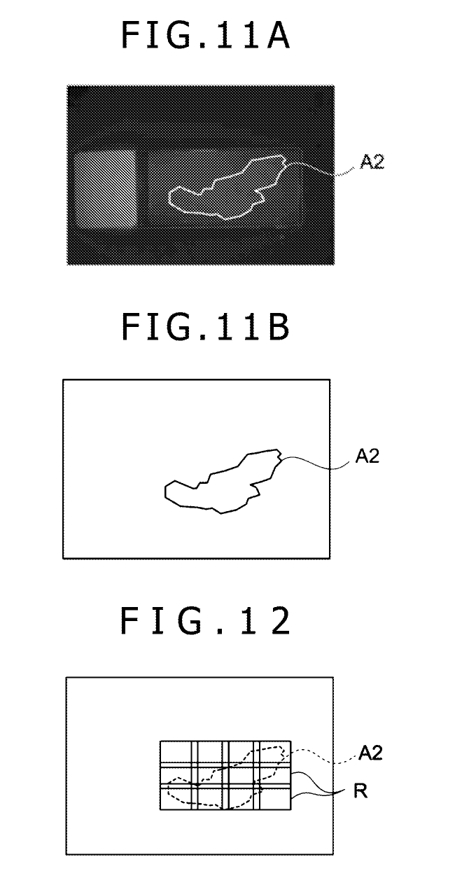

Next, the second area detecting portion 42 detects “a specimen material area” in the second low-magnification image (St202). The specimen material area is an area in which the second observation object, that is, the section of the pork loin in this case exists. FIGS. 11A and 11B are respectively schematic views each showing the specimen material area thus detected. FIG. 11A shows a profile of the specimen material area in a state in which the profile of the specimen material area is superimposed on the low-magnification image, and FIG. 11B shows the profile of the specimen material area, and a peripheral edge of the second low-magnification image. In FIGS. 11A and 11B, the profile of the specimen material area is shown as an area A2.

In the subsequent step, the microscope system 1 picks up the image of the specimen material area at the high magnification. However, since it becomes wasteful to picks up an image of an area in which no observation object exists at the high magnification, in the processing in Step St202, an area is detected in which the observation object whose image is to be picked up at the high magnification exists. Processing, utilizing contrasts (visual features such as a luminance and a color) of an image, such as area extraction based on the threshold value processing and labeling processing, or edge detection using a digital filter can be used for detection of the specimen material area.

Next, the image processing apparatus 4 sets “a microscope imaging range” in the second low-magnification image (St203). FIG. 12 is a view conceptually showing the microscope imaging range. A specimen material area (an area A2), and the microscope imaging range (shown as a range R) set on the specimen material area are both shown in FIG. 12.

The microscope imaging range is a range corresponding to the visual view range of the high-power imaging device 21 through the high-power lens barrel 22 set to a predetermined enlargement magnification. The image processing apparatus 4 determines a size of the microscope imaging range in correspondence to the enlargement magnification inputted by the user. When the entire specimen material area is not contained in one microscope imaging range, as shown in FIG. 12, the image processing apparatus 4 disposes plural microscope imaging ranges. It is noted that the image processing apparatus 4 can dispose the microscope imaging ranges in such a way that as shown in FIG. 12, peripheral edge portions thereof are superimposed on one another. This process is carried out for convenience in a microscopic image coupling step which will be described later.

Next, the image processing apparatus 4 calculates “the coordinates of a position of the stage” as the coordinates of the position of the stage 23 for fitting each of the microscope imaging ranges described above within the visual view of the high-power imaging device 21 (St204). Specifically, the image processing apparatus 4 calculates a difference between the coordinates of a central position of the second low-magnification image, and the coordinates of a central position of one microscope imaging range. Also, the image processing apparatus 4 applies the resulting difference to the coordinates, of the position of the stage 23 when the second low-magnification image is picked up, data on which is supplied from the microscope control unit 3, and sets the resulting coordinates as the coordinates of the position of the stage 23 about the microscope imaging range concerned. The image processing apparatus 4 outputs the data on the coordinates of the positions of the stage 23 corresponding to the microscope imaging ranges, respectively, to the microscope control unit 3. In addition, when plural microscope imaging ranges are set in the image processing apparatus 4, the image processing apparatus 4 determines the most efficient order of the imaging, that is, the order of the imaging with which the drive distance of the stage 23 becomes shortest, and outputs data on the order of the imaging to the microscope control unit 3.

Next, the microscope control unit 3 moves the position of the stage 23 by using the stage driving portion 24 (St205). The microscope control unit 3 controls the stage driving portion 24 in such a way that any one of the microscope imaging ranges agrees with the visual view of the high-power imaging device 21 in accordance with the data on the coordinates of the position of the stage 23 supplied thereto in the processing in St204.

Next, the high-power imaging device 21 picks up “a microscopic image” of the preparation P2 (St205). The microscopic image is a microscopic enlarged image of the preparation P2. The microscope control unit 3 outputs a control signal to the high-power lens barrel 22 in such a way that the enlargement magnification specified by the user is obtained, and the focus is obtained at the enlargement magnification thus specified. The high-power imaging device 21 outputs the data on the microscopic image to the image processing apparatus 4.

When plural microscope imaging ranges are set in the image processing apparatus 4, the microscope control unit 3 moves the position of the stage 23 again by using the stage driving portion 24, and causes the high-power imaging device 21 to pick up an image of the next microscope imaging range of the preparation P2. The microscope control unit 3 repetitively carries out both of the movement of the position of the stage 23 (St205), and the imaging of the microscopic image by the high-power imaging device 21 (St206) until the images of all of the microscope imaging ranges are picked up.

When plural microscopic images adjacent to one another are picked up, the image processing apparatus 4 couples the individual microscopic images to one another (St207). Specifically, the image processing apparatus 4 extracts plural feature points in a superimposing range of the two sheets of adjacent microscopic images, and can stitch these images in such a way that the feature points thus extracted agree with one another. As a result, even when the continuous specimen material areas are larger in size than one microscope imaging range, it becomes possible to acquire the continuous microscopic image of the continuous specimen material areas concerned. The microscopic image, obtained through the coupling, of the preparation P2 thus produced is set as “a second high-magnification image.”

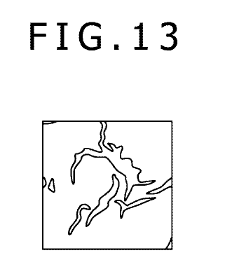

FIG. 13 is a schematic view of the second high-magnification image. Here, the second high-magnification image shown in FIG. 13 is a part of the second observation object. The reason for this is because as described above, in the preparation P2, the cover glass covers only the central portion of the second observation object, which results in that an image of the area in which no cover glass exists is out of focus in the microscope 2, and thus may not be picked up. Since no image of the profile of the second observation object is contained in the second high-magnification image as shown in FIG. 13, it may be impossible to carry out the alignment using the first high-magnification image and the profile. Details of the alignment will be described later.

Next, the image processing apparatus 4 divides the second high-magnification image into image tiles (St208). The image processing apparatus 4 divides the second high-magnification image into plural square partitions, for example, 256 square partitions. This process is carried out for the purpose of saving a storage capacity of a memory or the like in the case where the second high-magnification image is displayed on the display device 5, and making the handling of the second high-magnification image easy. The image processing apparatus 4 adds predetermined pieces of positional information on the image tiles in the second high-magnification image to headers of the image tiles, respectively.

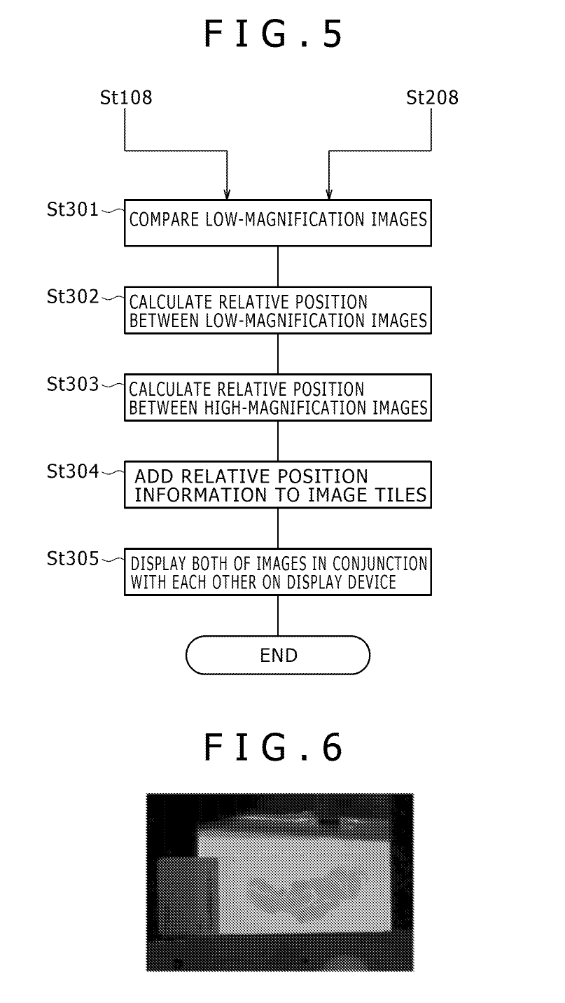

The operation of the microscope system 1 for the second observation object shown in FIG. 4 is as described above. Subsequently, the operation of the microscope system 1 proceeds to an operation for comparing the image of the first observation object, and the image of the second observation object shown in FIG. 5. It is noted that the operation of the microscope system 1 for the first observation object, and the operation of the microscope system 1 for the second observation object may be reversed in order.

### Operation for Comparing Image of First Observation Object and Image of Second Observation Object

A description will now be given with respect to the operation for comparing the image of the first observation object and the image of the second observation object with each other in the microscope system 1. FIG. 5 is a flow chart showing the operation for comparing the image of the first observation object and the image of the second observation object with each other in the microscope system 1.

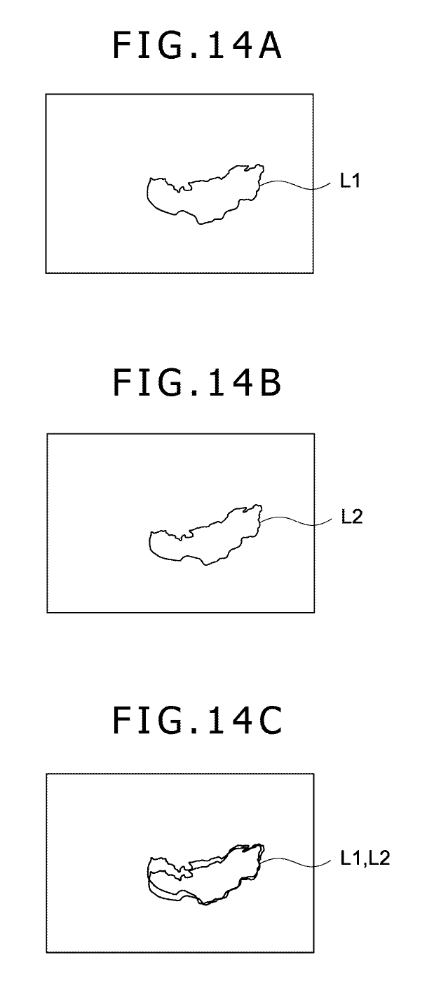

The image comparing portion 43 of the image processing apparatus 4 compares the first low-magnification image and the second low-magnification image with each other (St301). FIGS. 14A to 14C are respectively conceptual views showing a situation of the comparison of the first low-magnification image and the second low-magnification image by the image comparing portion 43. As shown in FIGS. 14A to 14C, the image comparing portion 43 extracts the profiles of the observation objects in the first low-magnification image and the second low-magnification image by using a difference in contrast between the areas in which the observation objects exist, respectively, in the first low-magnification image and the second low-magnification image. FIG. 14A shows the profile L1 of the observation object extracted from the first low-magnification image, and FIG. 14B shows the profile L2 of the observation object extracted from the second low-magnification image. As shown in FIG. 14C, the image processing apparatus 4 superimposes the profile L1 of the observation object in the first low-magnification image, and the profile L2 of the observation object in the second low-magnification image on each other in such a way that the peripheral edges of the first low-magnification image and the second low-magnification image agree with each other.

Next, the image comparing portion 43 calculates a relative position between the first low-magnification image and the second low-magnification image (St302). The relative position means a difference between the position of the first observation object in the first low-magnification image, and the position of the second observation object in the second low-magnification image. Specifically, the image comparing portion 43 calculates a difference in position coordinates of one point or plural points on the profile between the first low-magnification image and the second low-magnification image. The relative position, for example, is calculated in the firm in which how many millimeters between the first low-magnification image and the second low-magnification image are shifted in the x-direction, how many millimeters between the first high-magnification image and the second high-magnification image are shifted in the y-direction, and how many degrees between the first high-magnification image and the second high-magnification image are rotated. In addition, information that the distortion of the image such as the twist exists may be added in some cases.

Next, the image comparing portion 43 calculates a relative position between the first high-magnification image and the second high-magnification image (St303). The relative position means a difference between the position of the first observation object in the first high-magnification image, and the position of the second observation object in the second high-magnification image. As described above, both of the range of the first high-magnification image in the first low-magnification image, and the range of the second high-magnification image in the second low-magnification image become clear. For this reason, the image comparing portion 43 can obtain the relative position between the first high-magnification image and the second high-magnification image from the relative position between the first low-magnification image and the second low-magnification image.

Next, the image comparing portion 43 adds information on the relative position between the first high-magnification image and the second high-magnification image to the image tiles (St304). For each of the image tiles of the first high-magnification image, the image comparing portion 43 describes information used to specify the image tile of the second high-magnification image in which the relative position is closest to the corresponding one of the image tiles. In addition, for each of the image tiles as well of the second high-magnification image, the image comparing portion 43 describes information used to specify the image tile of the first high-magnification image in which the relative position is closest to the corresponding one of the image tiles.

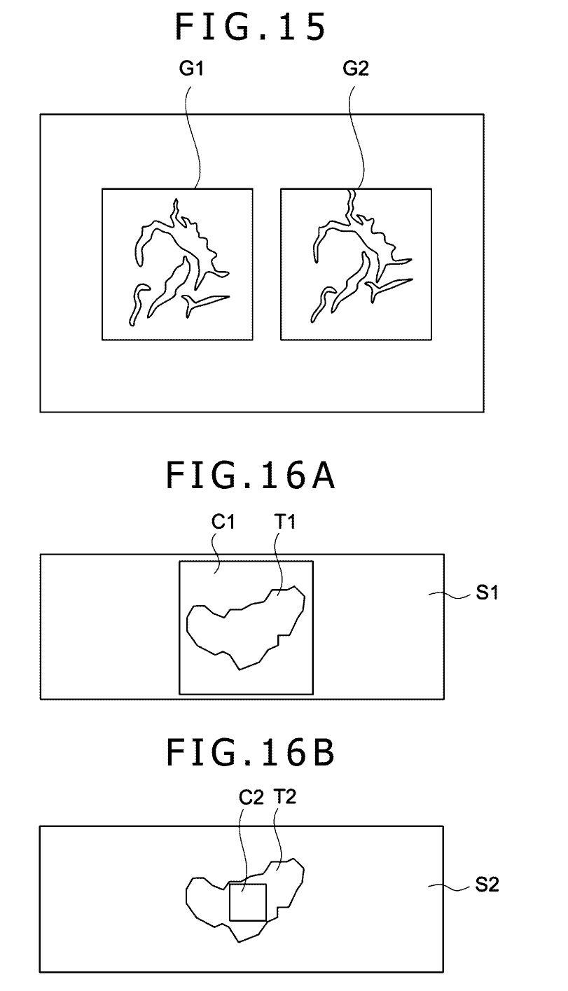

Next, the image displaying portion 44 displays the first high-magnification image and the second high-magnification image in conjunction with each other on the display device 5 (St305). FIG. 15 is a view showing an example of the first high-magnification image and the second high-magnification image both displayed on the display device 5. In FIG. 15, the first high-magnification image is shown as an image G1, and the second high-magnification image is shown in as image G2. As shown in FIG. 15, the image displaying portion 44 displays the mutually corresponding image tiles of the image tiles of the first high-magnification image, and the image tiles of the second high-magnification image on the display device 5. When the manipulation for the enlargement, the reduction, the movement, or the like for either the first high-magnification image or the second high-magnification image is inputted by the user, the image displaying portion 44 displays the image tiles of both of the first high-magnification image and the second high-magnification image in which the manipulation is reflected on the display device 5. That is to say, the image displaying portion 44 displays the first high-magnification image and the second high-magnification image in conjunction with each other on the display device 5.

In the manner described above, the microscope system 1 including the image processing apparatus 4 of the embodiment can display the first high-magnification image and the second high-magnification image in conjunction with each other on the display device 5. As a result, it becomes easy for the user to compare the microscopic images of the corresponding structures of the first observation object and the second observation object. In particular, even when the image of the profile of the observation object is contained neither in the first high-magnification image nor in the second high-magnification image, the microscope system 1 can display the first high-magnification image and the second high-magnification image in conjunction with each other on the display device 5.

The present disclosure is by no means limited to the embodiments described above, and thus various kinds of changes can be made without departing the subject matter.

Although in the embodiment described above, the entire image of the preparation whose image is picked up as the first low-magnification image at the same magnification or the like, the first low-magnification image is by no means limited thereto. For example, an image obtained through compression coding of the first high-magnification image as the microscopic image can also be set as the first low-magnification image.

The present disclosure contains subject matter related to that disclosed in Japanese Priority Patent Application JP 2010-270284 filed in the Japan Patent Office on Dec. 3, 2010, the entire content of which is hereby incorporated by reference.

What is claimed is:

1. An image processing method, comprising:
comparing a first low-magnification image as a low-magnification image of a first observation object, and a second low-magnification image of a second observation object similar to the first observation object with each other by an image comparing portion, thereby obtaining a difference between a position of the first observation object in the first low-magnification image, and a position of the second observation object in the second low-magnification image; and
displaying a first high-magnification image as a high-magnification image of the first observation object, and a second high-magnification image as a high-magnification image of the second observation object in conjunction with each other in accordance with the difference on a display device by an image displaying portion.

2. An image processing method, comprising:
detecting an area in which a first observation object exists as a first area in a first low-magnification image obtained by picking up an image of the first observation object at a low-magnification by a first area detecting portion;
detecting an area in which a second observation object exists as a second area in a second low-magnification image obtained by picking up an image of the second observation object similar to the first observation object at a low magnification by a second area detecting area;
comparing the first low-magnification image and the second low-magnification image with each other by an image comparing portion, thereby obtaining a difference between a position of the first observation object in the first low-magnification image, and a position of the second observation object in the second low-magnification image; and
displaying a first high-magnification image obtained by picking up an image of the first area at a high magnification, and a second high-magnification image obtained by picking up an image of the second area at the high magnification in conjunction with each other in accordance with the difference on a display device by an image displaying portion.

3. The image processing method according to claim 2, wherein with the obtaining of the difference by said image comparing portion, said image comparing portion obtains a profile of the first observation object in the first low-magnification image, and a profile of the second observation object in the second low-magnification image, and obtains the difference between a position of the profile of the first observation object in the first low-magnification image, and a position of the profile of the second observation object in the second low-magnification image.

4. The image processing method according to claim 3, wherein with the obtaining of the difference by said image comparing portion, said image comparing portion obtains the profile of the first observation object from a contrast of the first low-magnification image, and obtains the profile of the second observation object from a contrast of the second low-magnification image.

5. An image processing apparatus, comprising:
a first area detecting portion detecting an area in which a first observation object exists as a first area in a first low-magnification image obtained by picking up an image of a first observation object at a low magnification;
a second area detecting portion detecting an area in which a second observation object similar to the first observation object exists as a second area in a second low-magnification image obtained by picking up an image of a second observation object at the low magnification;
an image comparing portion comparing the first low-magnification image and the second low-magnification image with each other, thereby obtaining a difference between a position of the first observation object in the first low-magnification image, and a position of the second observation object in the second low-magnification image; and
an image displaying portion causing a display device to display thereon a first high-magnification image obtained by picking up an image of the first area at a high magnification and a second high-magnification image obtained by picking up an image of the second area at the high magnification in conjunction with each other in accordance with the difference.

6. An image processing program functioning so as to comprise:
a first area detecting portion detecting an area in which a first observation object exists as a first area in a first low-magnification image obtained by picking up an image of a first observation object at a low magnification;
a second area detecting portion detecting an area in which a second observation object similar to the first observation object exists as a second area in a second low-magnification image obtained by picking up an image of a second observation object at the low magnification;
an image comparing portion comparing the first low-magnification image and the second low-magnification image with each other, thereby obtaining a difference between a position of the first observation object in the first low-magnification image, and a position of the second observation object in the second low-magnification image; and
an image displaying portion causing a display device to display thereon a first high-magnification image obtained by picking up an image of the first area at a high magnification and a second high-magnification image obtained by picking up an image of the second area at the high magnification in conjunction with each other in accordance with the difference.
